(19) United States
(12) Patent Application Publication
(10) Pub. No.: US 2009/0077849 A1
(43) Pub. Date: Mar. 26, 2009

(54) MOLDED SIGN FRAME ASSEMBLY

(76) Inventors: Geoffrey M. Glass, JR., Lincolnshire, IL (US); Edward Poelsterl, Bensenville, IL (US); Stephen S. Simovits, JR., Downers Grove, IL (US)

Correspondence Address: BRINKS HOFER GILSON & LIONE, P.O. BOX 10395, CHICAGO, IL, 60610, US

(21) Appl. No.: 12/209,027

(22) Filed: Sep. 11, 2008

Related U.S. Application Data
(60) Provisional application No. 60/995,357, filed on Sep. 26, 2007.

(51) Int. Cl. G09F 15/00; B29C 45/00

(52) U.S. Cl. 40/606.03; 40/606.01; 40/606.19; 264/299

(57) ABSTRACT

A sign frame comprises a pair of upstanding leg members each having a proximate end and a tapered distal end, at least one top member connecting the leg members at the proximate ends thereof, and at least one cross member connecting the leg members between the proximate and distal ends thereof. The members together define a first sign mounting area. Within the sign frame is at least one mounting flange extending into the first sign mounting area from the sign frame, and at least one elongated stiffening rib upstands from and extends along each of the leg members.

### RELATED APPLICATIONS

The present application claims the benefit under 35 U.S.C. §119(e) to the filing date of U.S. Provisional Application Ser. No. 60/995,357, filed on Sep. 26, 2007, the entirety of which is hereby incorporated by reference.

### BACKGROUND

1. Technical Field

The present invention relates to signage. In particular, the present invention relates to a molded sign frame assembly for use in displaying signage, such as real estate-related signage.

2. Background Information

When selling a piece of property or land, it is common to post a simple sign in the region of a piece of property or structure that is being sold. For example, real estate agents typically erect an upstanding sign in the ground so that those passing by the property may view the sign and its marketing materials. The sign and marketing materials typically include identification information relating to the property, branding relating to the real estate agency or agent that is selling the property, and other information relating to the nature of the property. It is of course important that the sign be clearly visible to potential buyers.

In order for a sign to be visible from a roadway, it should be fairly large. However, it is important that the sign also be somewhat portable so that the selling agent may easily transport the sign using his or her automobile. It is important that the sign be readily and easily installed and removed from the property when needed. It is important that the signs be rigid enough to allow for proper visibility of the marketing materials in all kinds of wind and weather, and that the signs be able to withstand the elements without being damaged. Ideally, the signs should also be fairly inexpensive to manufacture, so that they may be widely used at minimal expense.

Various types of signs have been constructed out of light-weight materials in an attempt to provide strong construction and an aesthetically pleasing configuration. However, the strength and stiffness of the more lightweight sign materials tend to be lacking, and the manufacturing of such signs tends to be difficult.

Typically, sign frame assemblies include a pair of legs or other appendages that are inserted into the terrain or soil to support the sign in an upright position. Sometimes, when the ground is frozen or partially frozen, it becomes necessary for the user to apply hammer or sledge blows to the legs in order for the legs to be driven into the ground. Thus, the frame assemblies must be sufficiently strong to withstand such blows. Furthermore, the retention features of the frame should permit easy insertion and removal, as well as assuring that the sign remains upright due to wind-loading and the like. The sign frame should also be resistant to vandalism and theft.

### BRIEF SUMMARY

In one aspect of the present invention, a molded plastic sign holder is provided. The sign holder comprises a pair of upstanding leg members each having a proximate end and a tapered distal end, at least one top member connecting the leg members at the proximate ends thereof, and at least one cross member connecting the leg members between the proximate and distal ends thereof. The members together define a first sign mounting area. Within the sign frame is at least one mounting flange extending into the first sign mounting area from the sign frame, and at least one elongated stiffening rib upstands from and extends along each of the leg members.

In another aspect of the present invention, a molded plastic sign holder is provided comprising a pair of upstanding leg members each having a proximate end and a tapered distal end, at least one top member connecting the leg members at the proximate ends thereof, and at least one cross member connecting the leg members between the proximate and distal ends. The leg members, the top member and the cross member together define a first sign mounting area. A continuous, closed mounting flange is molded to the members and extends along a perimeter of the first sign mounting area. Further, a plurality of stiffening ribs extends from each of the leg members, the top member and the cross member.

In yet another aspect of the present invention, a molded plastic sign holder is provided wherein a sign frame comprises a pair of leg members, a top member and a cross member, to define a first sign mounting area. Stiffening ribs extend parallel to each other along at least a portion of the leg members, the top member and the cross member of the sign frame, and a first flange extends into the first sign mounting area from the sign frame. The flange member extends between at least the top member and at least one leg member to reinforce the sign frame.

In yet another aspect of the present invention, a molded plastic sign holder is provided wherein a sign frame comprises a pair of leg members, a top member and a cross member, to define a first sign mounting area. The cross-sectional structure of the leg members may be comprised of parallel members with a center member there between. The center member may extend between center regions of the parallel members. Alternatively, the center member may extend between end portions of the parallel members. The cross-sectional structure of the top member and cross member may also be comprised of parallel members with a center member extending therebetween. In this case, the center member may extend between center regions of the parallel members. The molded plastic sign holder may also comprise an elongated mounting member formed on one of the leg members on the opposite side of the first sign mounting area for slidably receiving an accessory container. A flange member may extend between the top member and at least one leg member to reinforce the sign frame.

In yet another aspect of the present invention, a method of making a plastic sign holder is provided. In the method, a pair of leg members, a top member and a cross member are molded together to define a sign frame defining a first sign mounting area. Plastic ribs are molded along at least a portion of the leg members, the top member and the cross member, and a continuous plastic flange is molded to the leg members, the top member and the cross member to define a sign mounting area.

These and other features and advantages of the invention will become apparent upon the review of the following detailed description of the presently preferred embodiments of the invention, taken in conjunction with the appended figures.

### BRIEF DESCRIPTION OF THE DRAWINGS

FIG. 1 is a perspective view of a sign holder in accordance with a first embodiment of the present invention;

FIG. 2 is a front view of the sign holder illustrated in FIG. 1;

FIG. 3 is a rear view of the sign holder illustrated in FIG. 1;

FIG. 4 is a right side view of the sign holder illustrated in FIG. 1;

FIG. 5 is a left side view of the sign holder illustrated in FIG. 1;

FIG. 6 is a top view of the sign holder illustrated in FIG. 1;

FIG. 7 is a bottom view of the sign holder illustrated in FIG. 1;

FIG. 8 is an enlarged perspective view of the leg foot platform of the sign holder shown in the above Figs., in particular on the right side leg member;

FIG. 9 is an enlarged cross-sectional view taken on line 9-9 of FIG. 3;

FIG. 10 is an enlarged cross-sectional view taken on line 10-10 of FIG. 3;

FIG. 11 is an enlarged cross-sectional view taken on line 11-11 of FIG. 3;

FIG. 12 is an enlarged cross-sectional view taken on line 12-12 of FIG. 3;

FIG. 13 is an enlarged cross-sectional view taken on line 13-13 of FIG. 3;

FIG. 14 is an enlarged cross-sectional view taken on line 14-14 of FIG. 3;

FIGS. 15-20 correspond to cross-sectional views of the sign holder in a second embodiment of the invention;

FIG. 15 is an enlarged cross-sectional view similar to the cross-sectional view taken on line 9-9 of FIG. 3;

FIG. 16 is an enlarged cross-sectional view similar to the cross-sectional view taken on line 10-10 of FIG. 3;

FIG. 17 is an enlarged cross-sectional view similar to the cross-sectional view taken on line 11-11 of FIG. 3;

FIG. 18 is an enlarged cross-sectional view similar to the cross-sectional view taken on line 12-12 of FIG. 3;

FIG. 19 is an enlarged cross-sectional view similar to the cross-sectional view taken on line 14-14 of FIG. 3;

FIG. 20 is an enlarged cross-sectional view similar to the cross-sectional view taken on line 13-13 of FIG. 3;

FIGS. 21-23 correspond to cross-sectional views of the sign holder in a third embodiment of the invention;

FIG. 21 is an enlarged cross-sectional view similar to the cross-sectional view taken on lines 12-12 of FIG. 3;

FIG. 22 is an enlarged cross-sectional view similar to the cross-sectional view taken on lines 14-14 of FIG. 3; and

FIG. 23 is an enlarged cross-sectional view similar to the cross-sectional view taken on lines 13-13 of FIG. 3.

### DETAILED DESCRIPTION

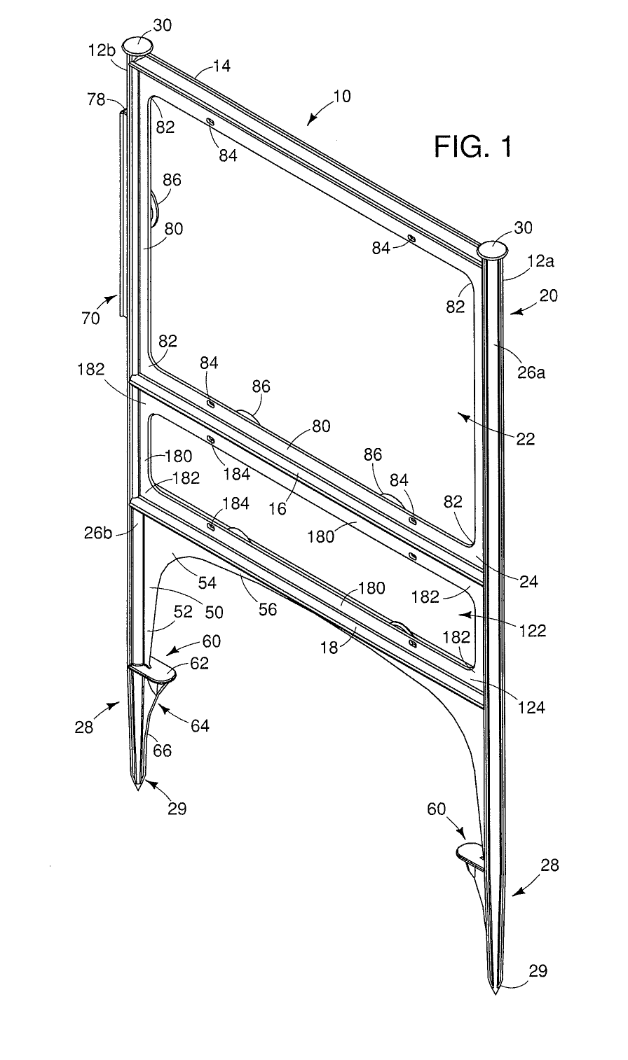

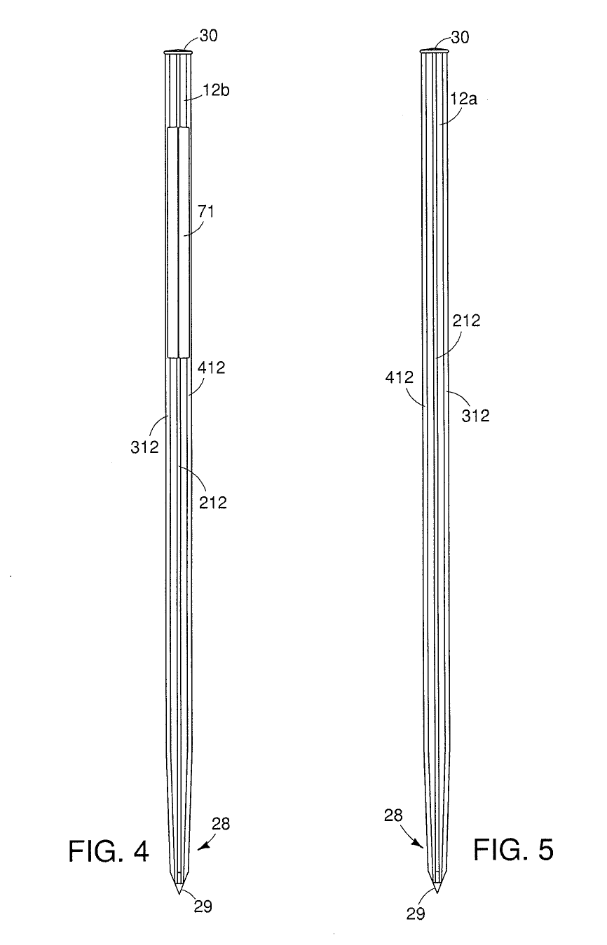

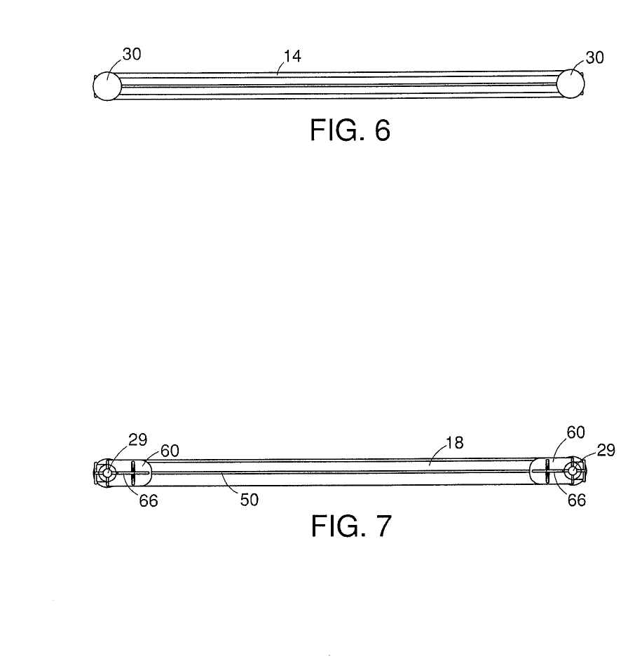

FIGS. 1-14, which will be referred to in combination below, illustrates a preferred embodiment of a sign frame assembly 10 in a perspective view. As shown in the FIG. 1, the sign frame assembly 10 includes a molded plastic body comprised of a pair of upright leg members 12a and 12b, a top member 14, a first cross member 16, and a second cross member 18. Together these members 12a, 12b, 14 and 16 define a first sign mounting area 22. The first sign mounting area 22 is a generally rectangular, planar space within the perimeter defined by the members 12a, 12b, 14 and 16, although any shape may be defined, such as oval, circular or square. In the preferred embodiments, the top member 14, the first cross member 16, and the second cross member 18 extend substantially perpendicularly to the upright leg members 12a and 12b.

The sign mounting area 22 of the sign frame assembly 10 includes a first mounting flange 24 positioned around the perimeter of the sign mounting area 22. The first cross member 16, the second cross member 18, and the two leg members 12a and 12b define a second sign mounting area 122 which, similar to the sign mounting area 22, includes a second mounting flange 124 attached to the perimeter. Attached to the inside portions of the legs 12a and 12b, and the bottom of the second cross member 18, is a reinforcing flange 50. The flanges 24, 124 and 50 are generally flat, molded plastic, and the flanges 24, 124 and 50 extend within planes that are either coplanar to each other or parallel to each other. The flange structures provide stability to the sign frame assembly 10 by bracing the open portions of the sign frame assembly 10 and preventing movement out of square between the leg members 12a and 12b and the horizontally extending members 14, 16 and 18. The structure of these mounting flanges 24, 124, and 50 will be discussed further below.

The upright leg members 12a and 12b are generally tubular in cross section in the preferred embodiment. In particular, the legs 12a and 12b comprise elongated cylinders 26a and 26b having a curved outer surface. The members 26a and 26b may in the alternative be hollow in the form of tubes. Furthermore, the legs 12a and 12b may be made from rectangular or square stock. Each of the legs 12a and 12b includes a tapered distal end 28 that gradually narrows in cross-sectional diameter. The legs 12a and 12b terminate at their distal ends in a point 29. The tapered ends 28 and the point 29 allow the upright legs 12a and 12b of the sign frame assembly to be easily inserted into the ground. At the proximal end of the legs 12a and 12b, a cap 30 is positioned. The caps 30 lend a pleasing appearance to the top portion of the sign, and also provide an area that may be struck by a hammer or mallet to facilitate driving the legs into difficult-to-penetrate substrates such as frozen ground, etc.

To further assist the user in inserting the legs 12a and 12b of the sign frame assembly 10 into substrates, each leg 12a and 12b is provided with a foot platform 60 near the tapered end 28 of each leg. As shown in more detail in FIG. 8, which is an enlargement of the right leg 12b, the foot platform 60 includes a flat shelf portion 62 extending horizontally and substantially perpendicularly to the cylindrical member 26b of the leg 12b. The flat shelf portion 62 may include a thread or other non-slip surface on a top side thereof. The underside of the flat shelf portion 62 includes a tapered brace 64 which is molded to a projecting rib 66. The rib 66 tapers further toward the distal end of the leg 12b as shown. In use, the user may place his or her foot on the flat shelf portion 62, while holding on to an upper portion of the sign frame assembly 10, such as the top member 14. By shifting the user's weight through the foot onto the flat shelf portion 62, the user may drive the leg portions 12a and 12b individually into the substrate.

In addition to facilitating insertion, the flat shelf portion 62 of the foot platform 60 prevents the legs 12a and 12b from being driven too far into the substrate. By acting as “stops”, the foot platforms 60 provide a simplified way for the user to determine if the sign frame assembly 10 is leveled relative to the surface of the substrate. Furthermore, the tapered brace 64 and the elongated rib 66 provide a larger insertion base to add stability to the sign as it is positioned within a substrate. Thus, a deformable substrate, such as compacted soil, will contact more surface area of the sign frame assembly 10 below the surface, thereby “gripping” and stabilizing the positioning of the assembly.

The first sign mounting flange 24, as noted above, comprises a generally planar frame that is mounted to the inner perimeter of the legs 12a, 12b, top member 14 and first cross member 16. Preferably, the first mounting flange 24 includes at least one elongated portion 80 attached or integrally molded to each of the elongated portions along the length of the legs 12a, 12b, top member 14 and first cross member 16. Curved fillets 82 join the elongated portions 80 to provide an integral flange having maximum structural stiffness. The first mounting flange 24 also defines a plurality of openings 84 which are used to accept the fasteners (not shown) to hold signage or marketing materials within the sign mounting area 22. While the mounting flange 24 is shown in the preferred embodiment to be a substantially continuous frame all around the perimeter of the sign mounting area, it is contemplated that the flange may merely consist of detached or separate flange portions. Of course, stiffness is obtained by, at a minimum, installing flanges in the corners.

Similar to the first mounting flange 24, the second mounting flange 124 also includes elongated portions 180 connected by fillet portions 182 to form an integral, planar flange that is attached at its perimeters to the bottom of the first cross member 16, the other portion of the second cross member 18, and the inner portions of the legs 12a and 12b that extend between the first cross member 16 and the second cross member 18 as shown. Furthermore, the second mounting flange 124 also defines a plurality of openings 184 sized to accept fastening means for attaching further signage materials.

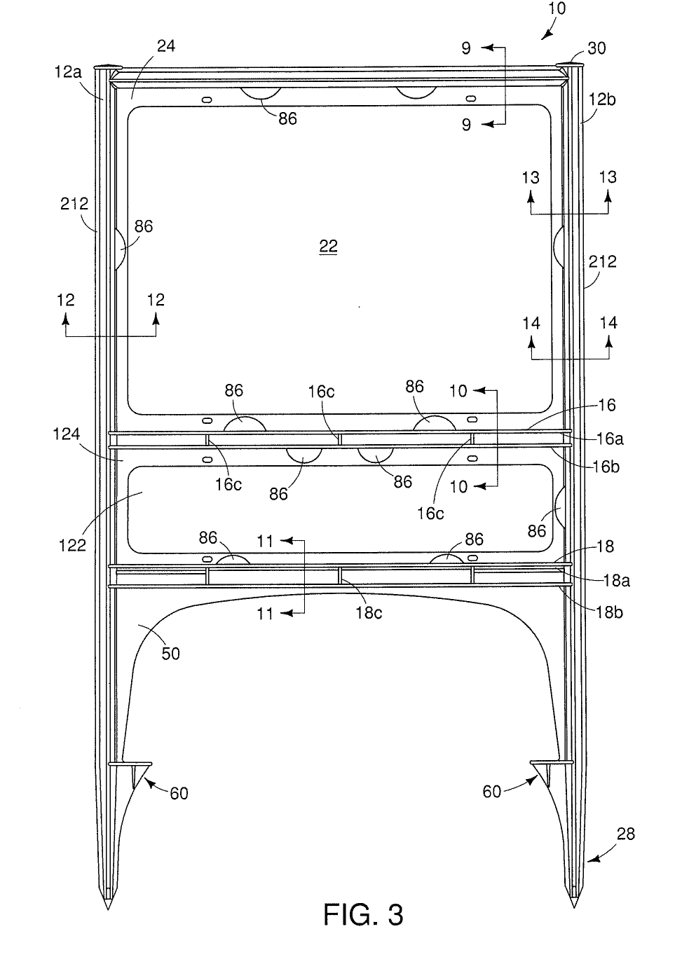

As shown in FIG. 3, which is a rear view of the sign frame assembly 10, a plurality of rigid, planar tabs 86 project inwardly from the legs and cross members. These tabs are spaced apart from the rear of the first mounting flange 24 and the second mounting flange 124 and are distributed about the perimeters of both the first and second sign mounting areas 22 and 122. The tabs 86 may be used to hold rigid signage against the rear of the first and/or second mounting flanges 24, 124.

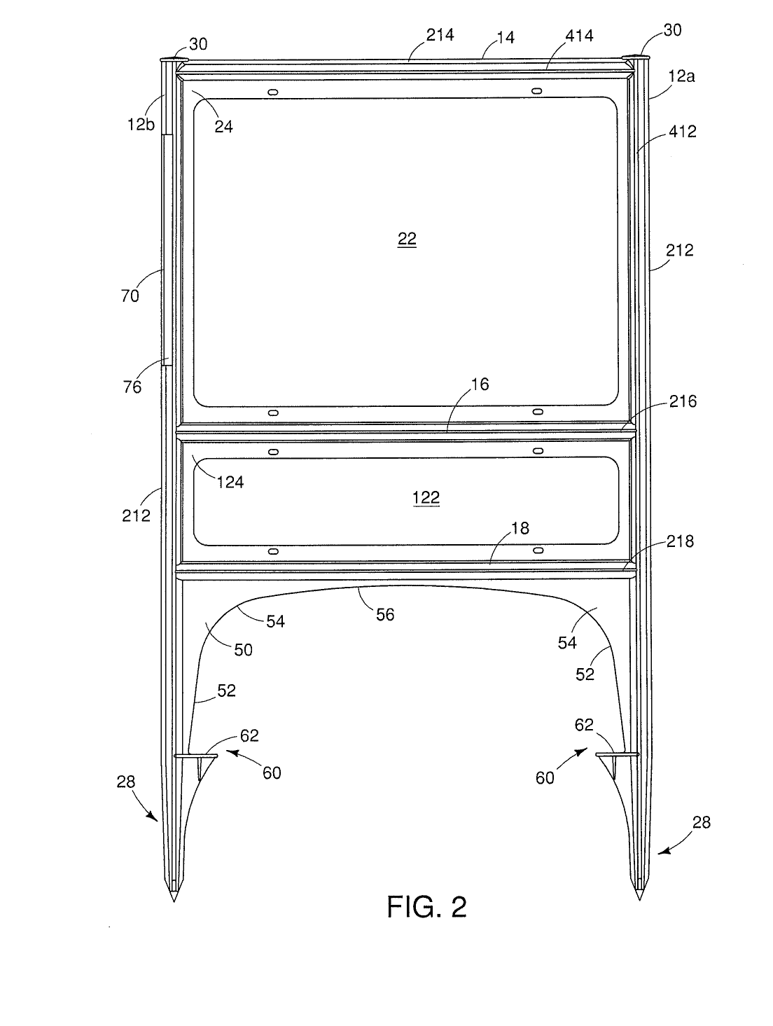

As shown more easily in FIG. 2, a structural reinforcing flange 50 is molded integrally with or rigidly attached to the bottom portion of the second cross member 18 and the inner portions of the legs 12a and 12b extending between the second cross member 18 and the flat shelf portion 62 of each of the foot platforms 60. The reinforcing flange 50 includes an elongated tapered portion 52 along each of the legs 12a and 12b, and an arched portion 56 near the center portion of the second cross member 18 in the preferred embodiment. The tapered portion 52 and the arched portion 56 are preferably linked or integral with a fillet portion 54.

The mounting flanges 24 and 124, along with the reinforcing flange 50, work together to provide lateral, 2-dimensional stiffness for the entire sign frame assembly 10. In this way, the joints in the corners between the elongated members remain square in the preferred embodiment.

To provide increased torsional and 3-dimensional stability and strength, a plurality of elongated strengthening ribs are molded integrally to the leg members 12a and 12b, the top member 14, and the first and second cross members 16 and 18. In order to more easily see the elongated ribs, cross sections of the various elongated members are shown in FIGS. 9-14. These cross-sections are keyed to FIG. 3. Some of the elongated ribs are visible in some of the elevation figures, where such may be done most clearly, in particular in FIGS. 2-5.

FIGS. 9-14 are cross-sectional views of various members of the sign frame assembly 10 in the preferred embodiment. Referring first to the cross section of Fig. 9, a cross-section illustration of the top member 14 is shown. First, it is noted that the first mounting flange 24 is positioned to slightly offset the diametrical line of the cross section of the top member 14. This is done primarily to reveal a more aesthetically pleasing portion of the entire sign frame assembly 10 in front of whatever signage is utilized or mounted on the first mounting flange 24. Of course, the mounting flange 24 may be positioned at any location relative to the cross section of any of the elongated members. Projecting or upstanding radially from the cross section of the top member 14 are the elongated flanges 414, 214 and 314 as shown. These upstanding ribs preferably extend nearly the entire length of the top member 14 to provide strength to the member. Preferably, the elongated ribs 414, 214 and 314 are distributed at generally regular intervals (in this case 90 degrees) around the circumference of the cross section of the top member 14. This is the case for all of the rounded cross-sectional members in the preferred embodiments, although any other distribution may be implemented.

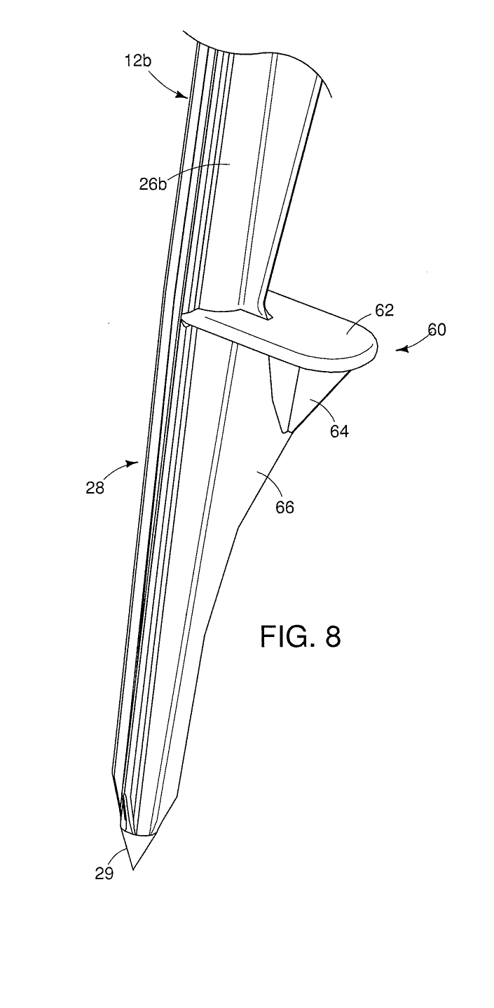

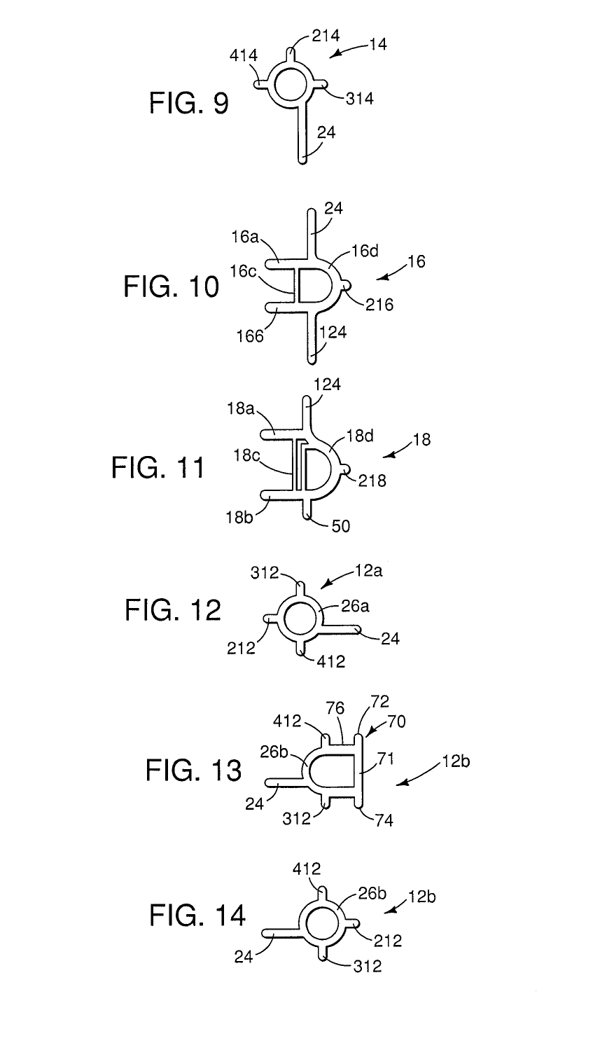

Turning now to FIG. 10, which is a cross section of the first cross member 16, a rounded portion 16d is shown on a front face of the sign frame assembly 10. The rear portion of the first cross member 16 includes a pair of parallel ribs 16a and 166 that project away from the rear side of the sign frame assembly 10 as shown. This may also be seen in the rear view of the sign frame assembly as shown in FIG. 3. The cross section of the first mounting flange 24 and the second mounting flange 124 may also be seen. A front elongated rib 216 projects on the front side of the sign frame assembly 10, preferably approximately 90 degrees along the curved portion of the cross member 16. As with the other elongated ribs, the rib 216 provides additional strength to prevent lateral or bending deformation of the cross member.

In FIG. 11, a similar cross section of the second cross member 18 is shown. The elongated rib 218 projects forwardly from the curved portion 18d of the cross section. Cross sections of the second mounting flange 124 and a portion of the reinforcing flange 50 may be seen. Similar to the first cross member 16, a pair of parallel ribs project rearwardly on the sign frame assembly 10 as upper rib 18a and lower rib 18b. These ribs preferably are connected using intermittent braces 18c as shown.

FIG. 12 and FIG. 14 show cross sections of the leg portions 12a and 12b, respectively. Similar to the arrangement in FIG. 9, three elongated ribs 312, 212 and 412 extend nearly the entire length of each leg 12a and 12b. The curved cylindrical portion of each leg is shown as 26a and 26b in the figures. As with the top member 14, the ribs 312, 212 and 412 are distributed around the circumference of each leg at approximate 90 degree intervals.

Finally, FIG. 13 is cut through a side mounting flange 70, which is integrally formed into the right leg 12b of the sign frame assembly 10. As shown in the cross section of FIG. 13, and as can be seen more clearly in FIG. 2, the mounting flange 70 includes a flat outer face 71 that is generally rectangular in shape. The face 71 defines a pair of extending lips 72 and 74 that project outwardly from straight walls 76. The straight walls 76 are substantially perpendicular to the face 71. The walls 76 are formed integral with the 180 degree remaining cylindrical arch of the cylindrical portion 26b, which forms a portion of the leg 12b. The mounting flange 70 may be used to receive a grooved portion of a box used to hold literature (not shown). In this fashion, the mounting flange 70 operates similar to a tongue-and-groove fixture so that the box may be slid onto the mounting flange 70. The remaining side ribs 312 and 412 may further be seen in FIG. 13.

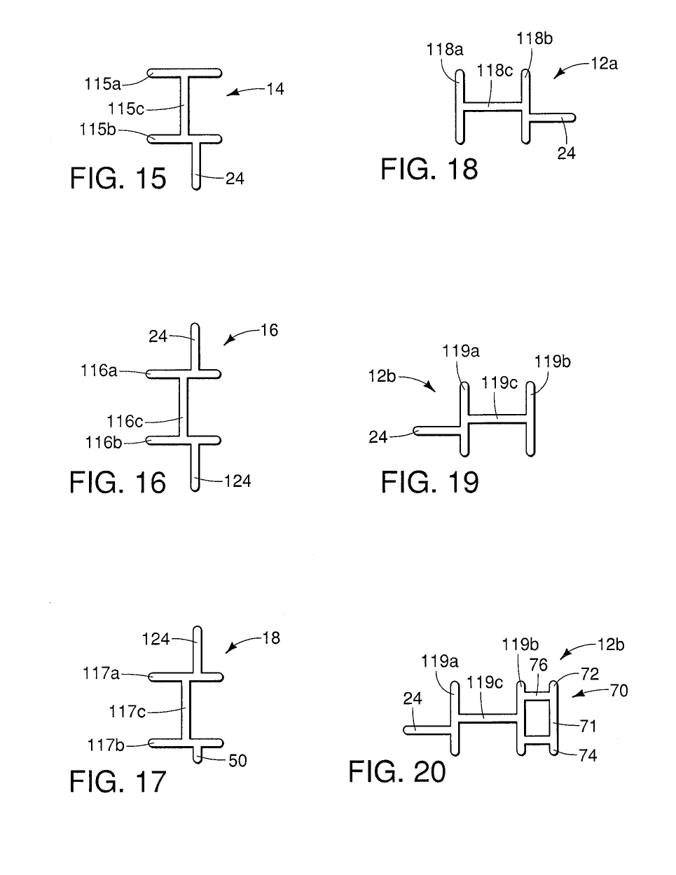

FIGS. 15-20 are cross-sectional views of various members of a second embodiment of the sign frame assembly. The cross-sections may be comprised of first and second parallel members and center members extending therebetween. This structure, sometimes referred to an “I-H” structure, may provide rigidity while minimizing weight and material usage and may form the basis of the cross-sectional structures of the second embodiment as described below.

Referring to FIG. 15, there is shown an enlarged cross-sectional view of a top member similar to the cross-sectional view of top member 14 taken on line 9-9 shown in FIG. 3. The structure may comprise a pair of parallel members 115a and 115b. A center member 115c may extend from a middle portion of the first parallel member 115a to a middle portion of the second parallel member 115b. Similar to the first mounting flange 24 shown in FIG. 9, a first mounting flange 24 may extend perpendicularly from the second parallel member 115b and may be positioned so that it is slightly offset from the center member 115c. It is to be understood that the first mounting flange 24 may be positioned at other locations relative to the center member 115c of the structure. Alternatively, the first mounting flange 24 may not be necessary as other methods may exist that enable mounting the signage to the frame. For example, the signage may be mounted to the frame via fasteners rather than via mounting flanges.

FIGS. 16 and 17 are enlarged cross-sectional views of first and second cross members similar to the cross-sectional views of the first cross member 16 and second cross member 18 taken on line 10-10 and 11-11 respectively as shown in FIG. 3. The structures shown may comprise a pair of parallel members 116a, 116b, 117a, and 117b and center members 116c and 117c. Referring to FIG. 16, first and second mounting flanges 24 and 124 may extend from the parallel members 116a and 116b of the structure. The mounting flanges 24 and 124 may be offset from the center member 116c of the structure. Referring to FIG. 17, the second mounting flange 124 may extend from the upper parallel member 117a of the structure. A portion of the reinforcing flange 50 may be seen extending from the lower parallel member 117b.

FIGS. 18 and 19 are enlarged cross-sectional views of a pair of upright leg members similar to the cross-sectional views of the upright leg members 12a and 12b taken on lines 12-12 and 14-14 respectively as shown in FIG. 3. As described above, the cross-sectional view of the pair of upright leg members 12a and 12b may be that of an “I-H” structure. Each leg member 12a and 12b may comprise a pair of parallel members 118a, 118b, 119a, and 119b and center members 118c and 119c. Referring to FIG. 18, the first mounting flange 24 may extend from the right parallel member 118b. The first mounting flange 24 may also extend from the left parallel member 119a as shown in FIG. 19.

FIG. 20 is an enlarged cross-sectional view of a right leg member similar to the cross-sectional views of the right leg member 12b taken on lines 13-13 as shown in FIG. 3. Similar to the structure of FIG. 19, the first mounting flange 24 may extend from the left parallel portion of the structure. A side mounting flange 70 for receiving a grooved portion of a box used to hold literature, as described with reference to FIG. 13 above, may extend from the right parallel member 119b.

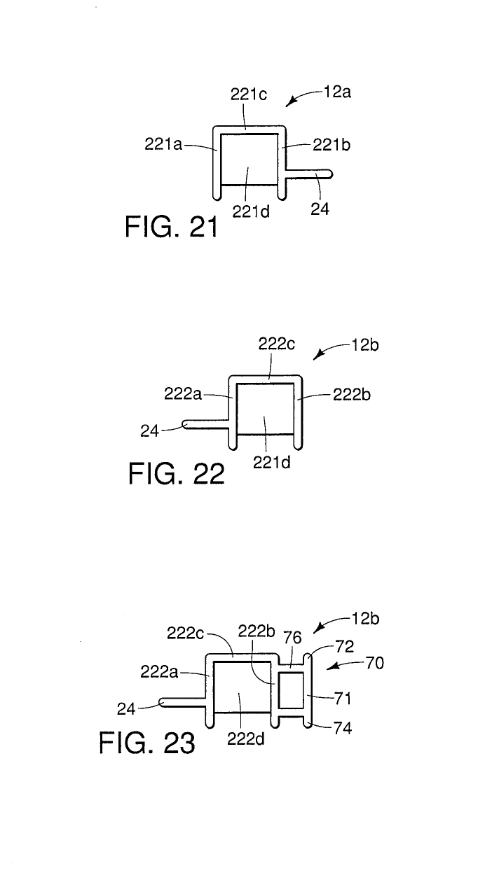

FIGS. 21-23 are cross-sectional views of a pair of leg members in a third embodiment of the sign frame assembly similar to the cross-sectional views of the leg members 12a and 12b of the sign frame assembly 10 taken on lines 12-12, 14-14, and 13-13 respectively, as shown in FIG. 3. As shown in FIGS. 21 and 22, the structure of the leg members 12a and 12b may comprise a pair of parallel side members 221a, 221b, 222a and 222b and connecting wall members 221c and 222c extending perpendicularly from an end of the first parallel side member 22a and 222b to an end of the second parallel side member 221b and 222b. The connecting wall members 221c and 222c may be seen from the front face of the sign frame assembly 10 and the interior portion defined by the parallel side members 221a, 221b, 222a, and 222b and the connecting wall members 221c and 222c may be seen from the rear of the sign frame assembly 10.

Intermittent braces 221c and 222c may be spaced along the interior of the structure and may provide increased torsional and 3-dimensional stability and strength to the sign frame assembly 10. As shown in FIG. 21, the first mounting flange 24 may extend from the right parallel member 221b. The first mounting flange 24 may also extend from the left parallel member 22a as shown in FIG. 22.

Referring to FIG. 23, the side mounting flange 70 for receiving a grooved portion of a box used to hold literature, as described with reference to FIG. 13 above, may extend from the right parallel member 222b. The cross-sectional views of the other members of the sign frame assembly 10 may be the same as those described in the preferred embodiment.

The embodiments of the sign frame assembly shown and described herein may be manufactured using various injection molding techniques. As noted above it is preferable that all of the components of the sign frame assembly 10 are molded together as a single piece. In the preferred embodiment, a two-plate mold is used to produce the sign frame assembly. Any type of commonly used plastic formulation suitable for use in injection molding operations, such as PVC, polypropylene, or nylon may be used. Other types of materials, such as foams, carbon composites and fiberglass, may also be used. In the preferred embodiment, a UV stabilizer may be added to the plastic prior to molding to provide added UV protection to the sign frame assembly. For example, a Hindered Amine Light Stabilizer (HALS) may be added prior to molding. Other UV stabilizers or additives commonly known to those of ordinary skill may be utilized as well.

Preferably, the elongated ribs and the elongated members 14, 16, 18 and 12a and 12b are integrally formed together. Thus, the entire shape of the sign assembly 10 may be molded in a single operation.

Of course, it should be understood that a wide range of changes and modifications can be made to the embodiment of the method described above. For example, the elongated ribs may be molded only to the legs of the assembly, while the horizontal members remain free of the ribs. Variations on these configurations are also possible. It is therefore intended that the foregoing detailed description be regarded as illustrative rather than limiting and that it be understood that it is the following claims, including all equivalents, which are intended to define the scope of this invention.

Any other undisclosed or incidental details of the construction or composition of the various elements of the disclosed embodiment of the present invention or methods of their use are not believed to be critical to the achievement of the advantages of the present invention, so long as the elements possess the attributes needed for them to perform as disclosed. The selection of these and other details of construction are believed to be well within the ability of one of even rudimentary skills in this area, in view of the present disclosure. Illustrative embodiments of the present invention have been described in considerable detail for the purpose of disclosing a practical, operative structure whereby the invention may be practiced advantageously. The designs and methods described herein are intended to be exemplary only. The novel characteristics of the invention may be incorporated in other structural forms without departing from the spirit and scope of the invention. The invention encompasses embodiments both comprising and consisting of the elements and steps described with reference to the illustrative embodiments. All technical terms shall take on their customary meaning as established by the appropriate technical discipline utilized by those normally skilled in that particular art area. It is therefore intended that the foregoing detailed description be regarded as illustrative rather than limiting. It should be understood that the following claims, including all equivalents, are intended to define the spirit and scope of this invention.

I claim:

1. A molded plastic sign holder comprising:
a pair of upstanding leg members each having a proximate end and a tapered distal end, at least one top member connecting said leg members at the proximate ends thereof, and at least one cross member connecting said leg members between the proximate and distal ends thereof, said leg members, at least one top member and at least one cross member defining a first sign mounting area;
at least one mounting flange extending into said first sign mounting area from said sign frame; and
at least one elongated stiffening rib upstanding from and extending along each of said leg members.

2. The molded plastic sign holder of claim 1, further comprising at least one elongated stiffening rib upstanding from and extending along said at least one top member and said at least one cross member.

3. The molded plastic sign holder of claim 1, wherein said at least one mounting flange further comprises a first mounting flange, said first mounting flange comprising a generally planar open frame extending along a perimeter of said first sign mounting area.

4. The molded plastic sign holder of claim 1, wherein said pair of upstanding leg members further comprise cylinders.

5. The molded plastic sign holder of claim 4, wherein said at least one top member further comprises a cylinder.

6. The molded plastic sign holder of claim 1, wherein said at least one cross member further comprises a pair of elongated ribs extending between said leg members.

7. The molded plastic sign holder of claim 1, further comprising two cross members extending between said leg members, said two cross members being spaced apart to define a second sign mounting area therebetween.

8. The molded plastic sign holder of claim 7, comprising a second mounting flange, said second mounting flange comprising a generally planar open frame extending along a perimeter of said second sign mounting area.

9. The molded plastic sign holder of claim 1, further comprising a foot platform extending from each of said leg members.

10. The molded plastic sign holder of claim 1, further comprising a generally planar reinforcing flange molded to a portion of said leg members and said at least one cross member below the first sign mounting area.

11. The molded plastic sign holder of claim 10, wherein said at least one elongated stiffening rib further comprises a plurality of stiffening ribs upstanding from at least a portion of said leg members in a direction opposite the reinforcing flange.

12. The molded plastic sign holder of claim 1, wherein a plurality of said stiffening ribs upstand in a plane parallel to said mounting flange and another plurality of said stiffening ribs upstand perpendicular to said mounting flange.

13. A molded plastic sign holder comprising:
a pair of upstanding leg members each having a proximate end and a tapered distal end;
at least one top member connecting said leg members at the proximate ends thereof;
at least one cross member connecting said leg members between the proximate and distal ends thereof, said leg members, at least one top member and at least one cross member defining a first sign mounting area;
a continuous, closed mounting flange molded to said leg members, said at least one top member and said at least one cross member and extending along a perimeter of said first sign mounting area; and
a plurality of stiffening ribs extending from each of said leg members, said at least one top member and said at least one cross member.

14. The molded plastic sign holder of claim 13, further comprising at least one elongated stiffening rib upstanding from and extending along said top member and said cross member.

15. The molded plastic sign holder of claim 13, wherein said mounting flange defines a plane substantially parallel to a plane of said first sign mounting area.

16. The molded plastic sign holder of claim 13, wherein said leg members further comprise cylinders.

17. The molded plastic sign holder of claim 13, further comprising two cross members extending between said leg members, said two cross members being spaced apart to define a second sign mounting area therebetween.

18. The molded plastic sign holder of claim 17, comprising a second mounting flange, said second mounting flange comprising a generally planar continuous frame extending along a perimeter of said second sign mounting area.

19. The molded plastic sign holder of claim 13, further comprising a foot platform extending from each of said leg members.

20. The molded plastic sign holder of claim 13, further comprising a generally planar reinforcing flange molded to a portion of said leg members and said at least one cross member below the first sign mounting area.

21. The molded plastic sign holder of claim 20, wherein said at least one elongated stiffening rib further comprises a plurality of stiffening ribs upstanding from at least a portion of said leg members in a direction opposite the reinforcing flange.

22. The molded plastic sign holder of claim 13, further comprising an elongated mounting member formed on at least one of said leg members on a side opposite said first sign mounting area for slidably receiving an accessory container.

23. A molded plastic sign holder comprising:
a sign frame comprising a pair of leg members, a top member and a cross member, said sign frame defining a first sign mounting area;
a plurality of stiffening ribs extending parallel to each other along at least a portion of said leg members; and
a first flange extending into said first sign mounting area from said sign frame, said at least one flange member extending between at least said top member and at least one leg member to reinforce said sign frame.

24. The molded plastic sign holder of claim 23, wherein said first flange further comprises a substantially flat member attached at its perimeter to the leg members, the top member and the cross member in said first sign mounting area.

25. The molded plastic sign holder of claim 23, wherein said first flange defines a plane substantially parallel to the plane of said first sign mounting area.

26. The molded plastic sign holder of claim 23, further comprising two cross members extending between said leg members, said two cross members being spaced apart to define a second sign mounting area therebetween.

27. The molded plastic sign holder of claim 26, comprising a second flange, said second flange comprising a substantially flat member attached to the leg members and to both of said cross members in said second sign mounting area.

28. The molded plastic sign holder of claim 27, further comprising a generally planar third flange molded to a portion of said leg members and said second cross member below the first sign mounting area.

29. The molded plastic sign holder of claim 28, wherein said at least one elongated stiffening rib further comprises a plurality of stiffening ribs upstanding from at least a portion of said leg members in a direction opposite the third flange.

30. The molded plastic sign holder of claim 23, further comprising a foot platform extending from each of said leg members.

31. The molded plastic sign holder of claim 23, further comprising an elongated mounting member formed on at least one of said leg members on a side opposite said first sign mounting area for slidably receiving an accessory container.

32. A molded plastic sign holder comprising:
a pair of upstanding leg members each having a proximate end and distal end;
at least one top member connecting said leg members at the proximate ends thereof; and
at least one cross member connecting said leg members between the proximate and distal ends thereof, said leg members, at least one top member and at least one cross member defining a first sign mounting area.

33. The molded plastic sign holder according to claim 32, wherein at least a portion of a cross-section of said pair of leg members comprises first and second parallel members and a center member extending therebetween.

34. The molded plastic sign holder according to claim 33, wherein said center member extends perpendicularly from a center region of said first parallel member to a center region of said second parallel member.

35. The molded plastic sign holder according to claim 33, wherein said center member extends perpendicularly from an end of said first parallel member to an end of said second parallel member.

36. The molded plastic sign holder according to claim 32, further comprising an elongated mounting member formed on at least one of said leg members on a side opposite said first sign mounting area for slidably receiving an accessory container.

37 The molded plastic sign holder according to claim 32, wherein at least a portion of a cross-section of said top member and cross member comprises first and second parallel members and a center member extending perpendicularly from a center region of said first parallel member to a center region of said second parallel member.

38. A method of making a plastic sign holder comprising:
integrally molding a pair of leg members, a top member and a cross member together to define a sign frame defining a first sign mounting area using injection-molded plastic;
forming plastic ribs along said leg members, said top member and said cross member using said plastic; and
forming a first sign mounting area within said sign frame by molding a continuous plastic flange to said leg members, said top member and said cross member.
